(19) United States
(12) Patent Application Publication
(10) Pub. No.: US 2006/0232990 A1
(43) Pub. Date: Oct. 19, 2006

(54) Lightning device with improved screen

(75) Inventor: Fabio Reggiani, Milan (IT)

Correspondence Address: HEDMAN & COSTIGAN P.C., 1185 AVENUE OF THE AMERICAS, NEW YORK, NY, 10036, US

(73) Assignee: REGGIANI S.p.A ILLUMINAZIONE

(21) Appl. No.: 11/399,199

(22) Filed: Apr. 6, 2006

(30) Foreign Application Priority Data
Apr. 13, 2005 (IT) MI2005A 000625

(51) Int. Cl. G02B 6/00

(52) U.S. Cl. 362/551

(57) ABSTRACT

A lighting device (10) composed of: at least one linear lamp (11) and a screen (12) associated with the lamp and comprising a plurality of spaced elements (13) set in a crosswise direction in relation to the lamp. According to the invention, said elements (13) are each composed of optical prisms.

The present invention relates to a lighting device equipped with a screen able to screen light glare, containing the luminous rays from the lamp within a predetermined angle in relation to the plane on which the lighting device is set, preferably less than 65°.

Lighting devices composed of a linear lamp (tube) and a screen comprising a plurality of blades with spaces between one another and set crosswise and at a certain distance in relation to the lamp, already exist in prior art.

Said blades are realised in a shiny material, generally aluminium, and have the main disadvantage of reducing the illuminating capacity of the lamp.

Also present in prior art are so-called light-guide systems wherein the lamp is completely screened and the light is guided within a transparent material that permits the light to exit at a certain predetermined angle in order to prevent undesirable glare.

Said light-guides are expensive and their yield is not totally satisfactory.

The general aim of the present invention is to eliminate the drawbacks encountered in prior art, by providing a lighting device equipped with a screen having a structure able to guarantee a strong illuminating capacity as well as adequate screening, in other words, able to prevent glare from disturbing people in the vicinity.

The specific aim of the present invention is to provide a lighting device with high yield adapted to screen the glare in one plane, containing the light rays within an angle of 65° in relation to the plane on which the said lighting device is set.

The aforesaid aims are achieved according to the invention, by a lighting device having the characteristics defined in the principal claim and following subordinate claims.

The structural and functional characteristics of the invention, and the advantages obtained when compared to prior art, will be made perfectly clear from the following description, with reference to the appended schematic drawings, which show certain embodiments of the said invention. In said drawings:

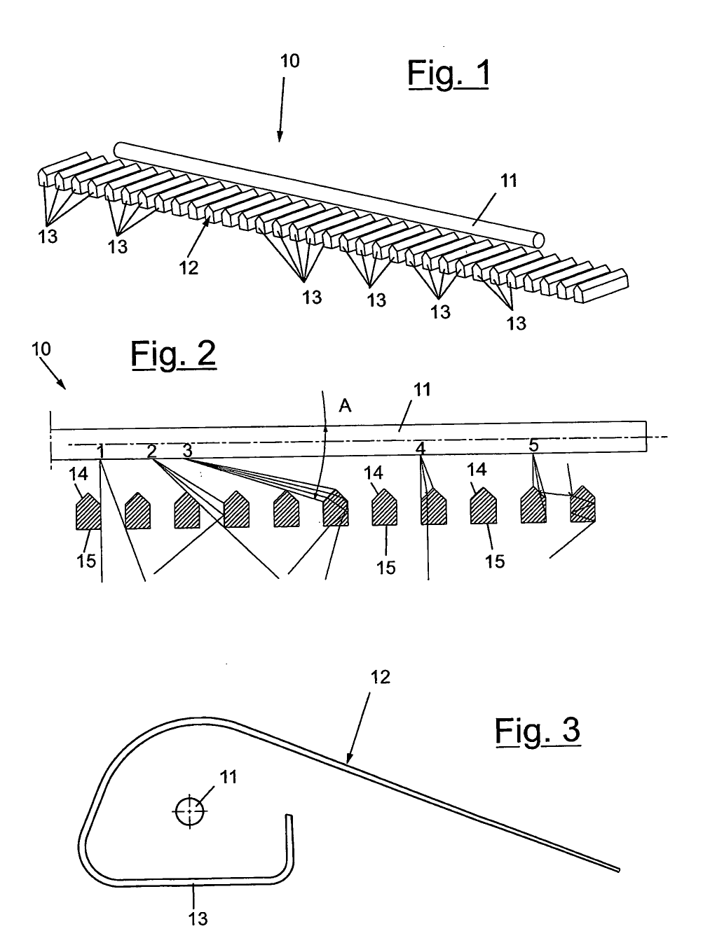

FIG. 1 shows a view in perspective of part of a lighting device realised according to the present invention;

FIG. 2 is a longitudinal cross section of the device shown in FIG. 1; and

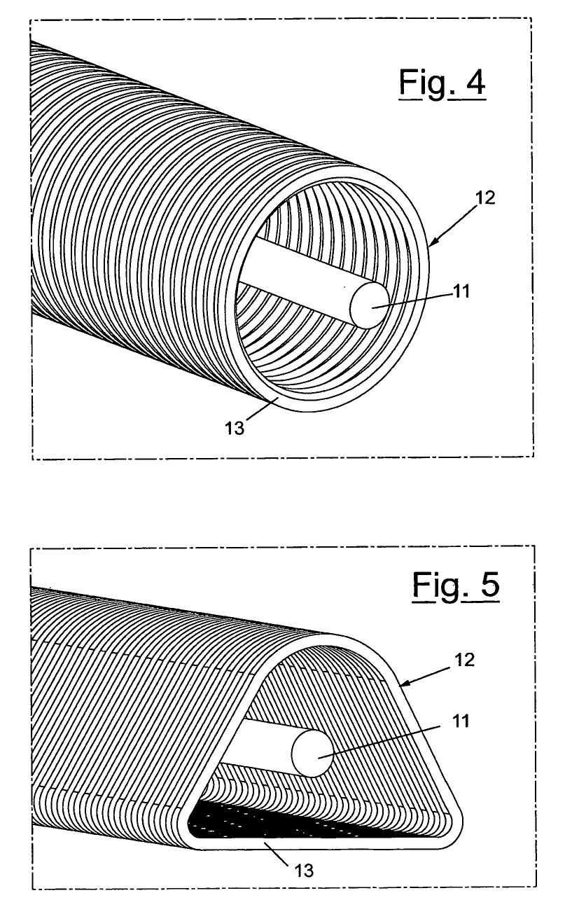

FIGS. 3 to 5 are schematic views of different screen geometries able to be used on lighting devices according to the present invention.

Firstly, with reference to FIGS. 1 and 2 in the drawings, the numeral 10 refers to a lighting device (schematic view), comprising a light source composed of a linear lamp 11 and of a screen 12 in the form of a plurality of spaced elements 13 set in a crosswise direction in relation to said lamp 11, and at a certain distance from the lamp. For the sake of simplicity, the other components of the lighting device are not shown. However, they are not necessary in order to understand the composition of the invention.

According to the present invention, the elements 13 that comprise the screen 12, are each characteristically composed of an optical prism having the capacity to contain the light rays from the linear lamp 11 within an angle of 65° in relation to the plane passing through the axis of lamp 11.

According to a preferred embodiment of the invention, provided simply as an example but by no means limiting, each of the said optical prisms is made of transparent acrylic material or a similar transparent material (plastic or glass) and presents a transversal section with a triangular portion 14, having a 90° angle at the vertex (facing the lamp) and a rectangular portion 15. Practical tests have shown that an excellent screening effect is obtained by leaving a gap measuring between 0 and 4 mm between two adjacent elements 13, as described above.

FIG. 2 in the drawings shows the path of five principal decomposed light rays from the lamp 11, where A identifies the angle in question.

Naturally, as shown in FIGS. 3 to 5 in a non-limiting embodiment, the screen 12, and therefore the elements 13, can be composed of one of a variety of forms, either flat, or revolving, and can totally or partially contain the light source 11, which can also be more than one in number.

A lighting device realised according to the principles of the invention achieves the highly desirable dual aim of guaranteeing strong illumination, as well as perfect screening.

The scope of protection of this invention is defined in the following claims.

1. Lighting device (10) of the type comprising at least one linear lamp (11) and one screen (12) associated with the lamp, composed of a plurality of spaced elements (13) set crosswise in relation to the lamp, characterised in that said elements (13) are each composed of optical prisms.

2. Lighting device (10) according to claim 1, characterised in that said optical prisms each present a transversal section having a triangular portion (14) and a rectangular portion (15).

3. Lighting device (10) according to claim 2, characterised in that said portion (14) is a triangle having a 90° angle at the vertex.

4. Lighting device (10) according to claim 1, characterised in that a gap measuring between 0 and 4 mm is left between two adjacent elements (13).

5. Lighting device (10) according to claim 1, characterised in that said optical prisms are made from transparent acrylic material or a similar transparent material (plastic or glass).

6. Lighting device (10) according to claim 1, characterised in that said screen (12) is flat.

7. Lighting device (10) according to claim 1, characterised in that said screen contains the lamp (11) at least partially.

8. Lighting device (10) according to claim 1, characterised in that said screen can be composed of any type of flat geometrical form, and can be applied even only to a portion of space where the angle of light needs to be contained in the longitudinal plane of the lamp.
